(19) United States
(12) Patent Application Publication
(10) Pub. No.: US 2016/0239873 A1
(43) Pub. Date: Aug. 18, 2016

(54) MEDIATION RECOMMENDATION SYSTEMS FOR MULTIPLE VIDEO ADVERTISEMENT DEMAND SOURCES

(71) Applicant: YUME, INC., Redwood City, CA (US)

(72) Inventors: Ayyappan SANKARAN, San Jose, CA (US); Sachin GUPTA, Fremont, CA (US); Alok NANDAN, San Francisco, CA (US); Vijay KAUSHIK, Fremont, CA (US)

(73) Assignee: YuMe Inc., Redwood City, CA (US)

(21) Appl. No.: 15/031,681

(22) PCT Filed: Nov. 6, 2014
(86) PCT No.: PCT/US14/64452

§ 371 Date: Apr. 22, 2016

Related U.S. Application Data
(60) Provisional application No. 61/900,954, filed on Nov. 6, 2013.

(51) Int. Cl. G06Q 30/02; H04N 21/254; H04N 21/466; H04N 21/81; H04N 21/262

(52) U.S. Cl. CPC G06Q 30/0267; H04N 21/812; H04N 21/26258; H04N 21/4668; H04N 21/254

(57) ABSTRACT

A system and method for mediation and recommendation for multiple electronic demand sources includes receiving at an advertisement (ad) server an ad request from a user device, initiating a mediation process on the ad server using an ad source policy and a priority that is provided with a publisher associated with the ad request and providing 3^{rd} party ad source recommendations to the user device. The user device preferably uses the 3^{rd} party ad source recommendations in a mediation waterfall process.

### FIELD

This invention relates general to electronic mediation systems, and more particularly to electronic mediation systems for online advertising networks.

### BACKGROUND

An online advertising (“ad”) network includes a server system that connects advertisers (“demand sources”) to publishers that want to display advertisements on connected screen devices such as personal computers (PCs), smartphones, Connected (Smart) Television (CTV or Smart TV), computer tablets, etc., that are connected to the Internet. A key function of an ad network is to aggregate ad space supply (“inventory”) from publishers and to match it with advertiser demand.

An ad network includes an ad server which facilitates the placement of advertisements on connected screen devices. An ad server is a web server associated with a database that directs advertisements to connected screen devices that are displaying contents provided by a publisher. In some cases, a publisher is a website provider and in other cases the publisher can be an application or “app” running on the connected screen device, or even the operating system of the connected screen device itself. The advertiser pays for the placement of the ad, where payment is typically split between the ad network and the publisher.

In many cases, an ad network is connected to multiple demand sources. The various types of demand sources can be generally categorized as: 1) direct sold campaigns (e.g. advertising campaigns run on behalf of a particular company); 2) network demand sources (e.g. advertisements from an advertising exchange or other network source); and 3) house ads (also known as remnant or last minute advertising). While publishers typically desire to maximize their revenues, they may not know which demand source is the most profitable. For that reason, publishers or publisher networks may assign a priority to various demand sources.

The demand sources chosen and the priorities allocated among the demand sources tends to be based upon educated guesses and are often less than optimal. Publishers may manually vary their allocations from time-to-time in an attempt to achieve a given goal, e.g. optimizing revenue, increasing interactivity, increasing usability, etc. but this is an expensive and inaccurate methodology and one which is prone to error in that there are a great many variables that can affect the results.

### SUMMARY

Various examples are set forth herein for the purpose of illustrating various combinations of elements and acts within the scope of the disclosures of the specification and drawings. As will be apparent to those of skill in the art, other combinations of elements and acts, and variations thereof, are also supported herein.

In an embodiment, set forth by way of example and not limitation, a mediation recommendation system/method for multiple demand sources is provided by embedding a mediation enabled SDK into a client device. In this example, when the SDK makes an Ad Request, a mediation process is initiated on an Ad Server using an Ad Source Policy bucket and priority that is provided by the publisher associated with that Ad Request. Throughout the process of providing and playing the ad on the client device, data concerning the selection, receipt and play of the ad is gathered by the Ad Server and an associated Beacon server and stored on a database for analysis.

In an embodiment, set forth by way of example and not limitation, a recommendation engine can use the database described above, along with other information it may have at its disposal, to recommend a change in ad sources and/or percentage user allocation among ad sources using, for example, content based approaches, collaborative filtering approaches, or hybrids thereof. These recommendations can be of various types, including economic recommendations, ad source accuracy, ad source performance, diversity, etc., and can be in the form of an ordered list.

In an embodiment, set forth by way of example and not limitation, a mediation recommendation system includes: a user device having a first digital processor, a first non-transient computer readable media, and a first network interface, where the first computer readable media includes mediation-enabled client Software Design Kit (SDK) program instructions executable on the first digital processor to provide a mediation waterfall and to communicate via the first network interface; and a recommendation server including a second digital processor, a second non-transient computer readable media, and a second network interface, the second computer readable media including program instructions executable on the second digital processor to provide recommendations and to communicate via the second network interface.

In an embodiment, set forth by way of example and not limitation, a method for mediation and recommendation for multiple electronic demand sources includes: receiving at an advertisement (ad) server an ad request from a user device; initiating a mediation process on the ad server using an ad source policy and a priority that is provided with a publisher associated with the ad request; and providing 3^{rd} party ad source recommendations to the user device.

An advantage of example systems and methods as disclosed herein is that certain publisher goals, e.g. revenue optimization, synergy with published content, etc., can be automatically addressed by providing recommendations to the publishers rather than requiring publishers to manually modify allocations and priorities of demand sources in an attempt to reach those goals.

These and other examples of combinations of elements and acts supported herein as well as advantages thereof will become apparent to those of skill in the art upon a reading of the following descriptions and a study of the several figures of the drawing.

### BRIEF DESCRIPTION OF DRAWINGS

Several examples will now be described with reference to the drawings, wherein like elements and/or acts are provided with like reference numerals. The examples are intended to illustrate, not limit, concepts disclosed herein. The drawings include the following figures:

FIG. 1 illustrates an example network system supporting a mediation recommendation system for multiple demand sources;

FIG. 2 is a block diagram of an example computer, computerized device, proxy and/or server which may form a part of the network system of FIG. 1;

FIG. 3 is a block diagram of an example ad fulfillment system including an ad network supporting a mediation recommendation system for multiple demand sources; and

FIG. 4 is an illustration of a mediation recommendation system/process for multiple demand sources.

### DESCRIPTION OF EMBODIMENTS

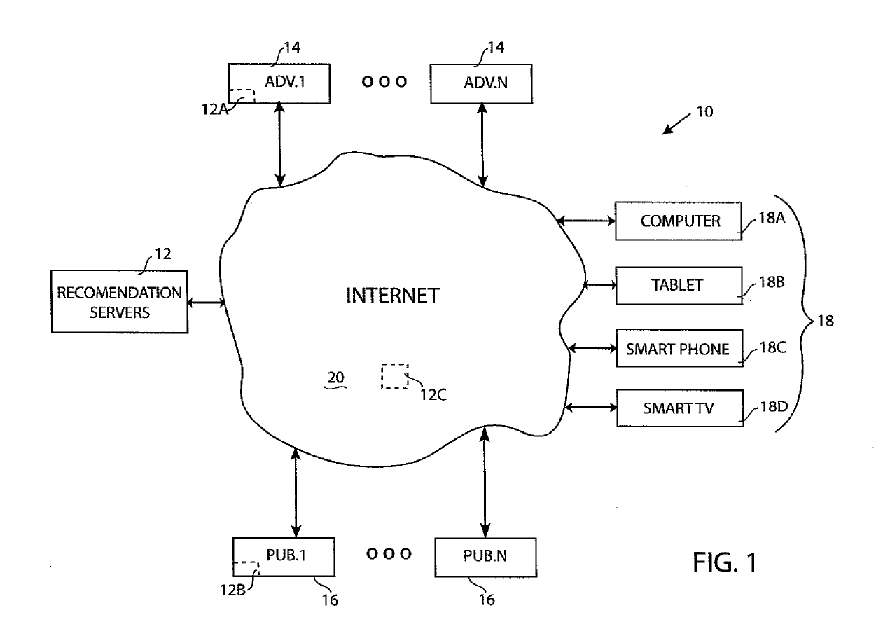

FIG. 1 illustrates a network system 10 supporting a mediation recommendation system and process for multiple demand sources in accordance with a non-limiting example. In this example, the network system 10 includes one or more recommendation servers 12, one or more advertiser servers 14 and one or more publisher servers 16. The system at 10 may further include other computers, servers or computerized systems such as user devices 18. In this example, the recommendation servers 12, advertiser servers 14, publisher servers 16, and user devices 18 can communicate by a wide area network such as the Internet 20 (also known as a “global network” or a “wide area network” or “WAN” operating with TCP/IP packet protocols).

The recommendation servers 12 can be implemented as a single server or as a number of servers, such as a server farm and/or virtual servers, as will be appreciated by those of skill in the art. Alternatively, the functionality of the recommendation servers 12 may be implemented elsewhere in the network system 10 such as on an advertiser server 14, as indicated at 12A, on the publisher server 16, as indicated at 12B, or as part as cloud computing as indicated at 12C, all being non-limiting examples. As will be appreciated by those of skill in the art, the processes of recommendation servers 12 may be distributed within network system 10.

In the example of FIG. 1, the network system 10 includes a plurality of advertiser servers 14 {ADV.1, ADV.2, . . . , ADV.N}. ADV.1 can be, for example, a manufacturer of soft drinks, ADV.2 can be a computer manufacturer and ADV. N can be, for example, an accounting firm. Alternatively, an advertiser can be an advertising agency acting as a middleman in the purchase of advertising for a client, can be an advertising (“ad”) network, or be an ad exchange. While each of the advertiser servers 14 may be implemented as a single computer, such as a network server, they can also represent other computer configurations, such as a computing cluster on a local area network (LAN).

It should further be noted that, in some instances, an ad network is, essentially, transparent to advertisers, publishers or both. That is, an ad network may be considered to be a publisher or collection of publishers to an advertiser and/or an ad network may be considered to be an advertiser or collection of advertisers to a publisher.

The publisher servers 16 can each represent one or more servers, such as a server farm. In the example of FIG. 1, the network system 10 includes a plurality of publisher servers 16 {PUB.1, PUB.2, . . . , PUB.M}. For example, PUB.1 can be an Internet portal, PUB.2 can be a search engine, and PUB.M can be a news website. As noted previously, one or more of the publisher servers 16 can implement some or all of the functionality of recommendation servers 12.

It should be noted that the selection of publishers can be enhanced by categorizing the publishers by, for example, content. That is, a “publisher” can be a single legal entity, or a subset of that entity, or a part of a group of entities, by way of several non-limiting examples. For example, a publisher entity may have 1000 publications of which 100 are directed to dramatic content, 100 are directed to comedy, etc. The subset of publications of the publisher entity having a common thematic content may be considered a “publisher.” Furthermore, “publishers” may include a group of publications provided by different agencies which conform to a theme such as, by way of non-limiting examples, drama, sports or entertainment. Also, as will be appreciated by those of skill in the art, publishers can also include application, app, operating system (OS) publishers operating on, for example, mobile user devices such as smartphones, tablet computers, etc.

User devices 18 can be any type of terminal, screen or device including, by way of non-limiting examples, a computer 18A, a connected TV (a/k/a Smart TV or CTV) 18D, a tablet 18B and a smartphone 18C. The distinguishing characteristics of user devices 18 include connectivity to the Internet 20 and display screens which can display, for example, advertisements delivered to the user devices over the Internet.

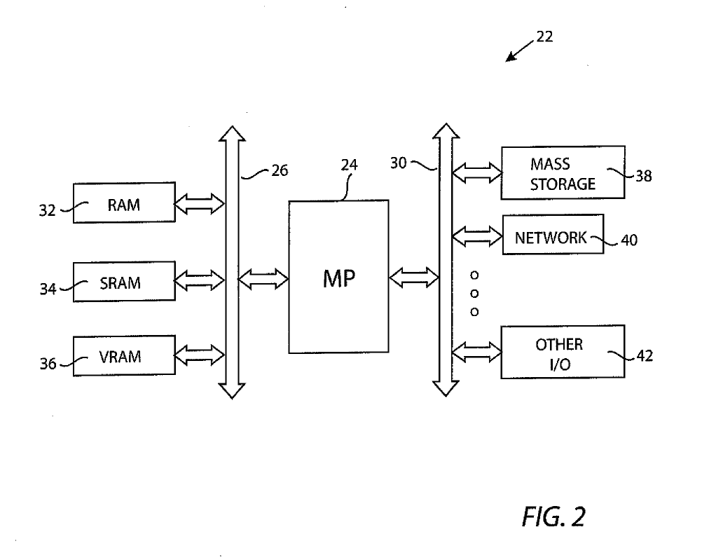

FIG. 2 is a simplified block diagram of a computer and/or server 22 suitable for use in network system 10. By way of non-limiting example, computer 22 includes a microprocessor 24 coupled to a memory bus 26 and an input/output (I/O) bus 30. A number of memory and/or other high speed devices may be coupled to memory bus 26 such as the RAM 32, SRAM 34 and VRAM 36. Attached to the I/O bus 30 are various

I/O devices such as mass storage 38, network interface 40, and other I/O 42. As will be appreciated by those of skill in the art, there are a number of computer readable media available to the microprocessor 24 such as the RAM 32, SRAM 34, VRAM 36 and mass storage 38. The network interface 40 and other I/O 42 also may include computer readable media such as registers, caches, buffers, etc. Mass storage 38 can be of various types including hard disk drives, optical drives and flash drives, to name a few.

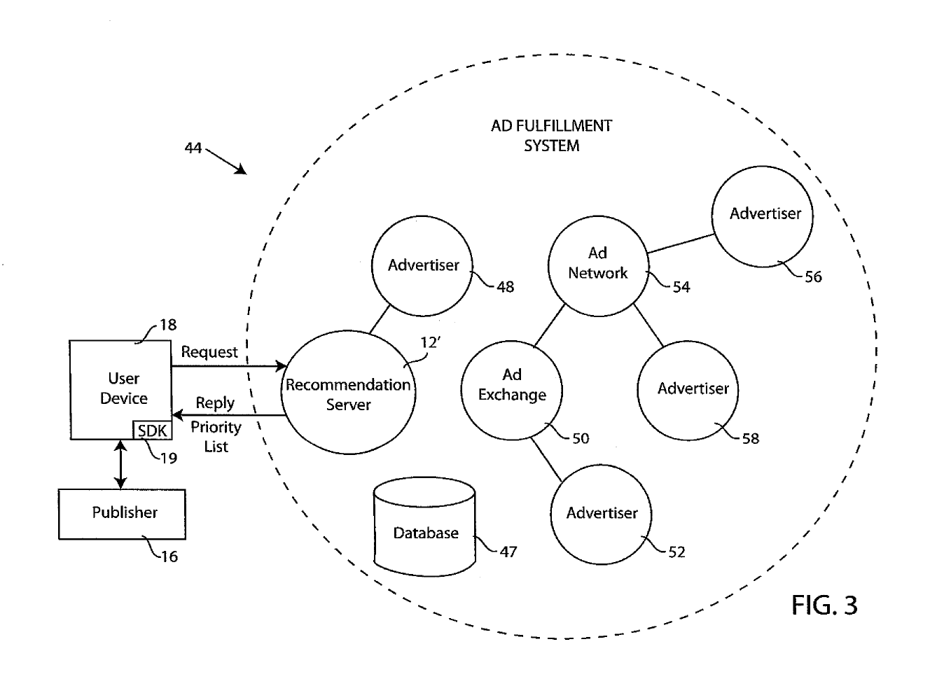

FIG. 3 illustrates, by way of example and not limitation, a User Device 18, a Publisher 16, and an Ad Fulfillment System 44, The User Device 18, in this non-limiting example, is a “connected” device in that it communicates with the Publisher 16 and the Ad Fulfillment System 44 via the Internet. In this non-limiting example, user device 18 uses a mediation-enabled SDK 19 to send a Request to a Recommendation Server 12′ of Ad Fulfillment System 44 and to receive a Reply in the form of an ordered list which, in this example, is referred to as a “Priority List.” The Ad Fulfillment System 44, of this example, is associated with a database 47 and includes one or more Advertisers 48 and one or more Ad Exchanges 50, both of which are examples of demand sources. The Ad

Exchanges 50, in turn, can be coupled to one or more Advertisers 52, one or more Ad Networks 54, etc. It will be appreciated that the network of the Ad Fulfillment System 44 can include other computers, databases and servers, e.g. Advertisers 56 and 58 connected to the Ad Network 54. However, at some point latency becomes an issue in that the person using the user device will typically only wait for a short period of time for an advertisement before “clicking out” and moving on to another screen.

It will be appreciated that, in this non-limiting example, the Recommendation Server 12′ is the gateway for the fulfillment of the ad request by the user device 18. The request to the Recommendation Server 12′ can be accomplished, by way of example, with a customized ad network SDK (Software Development Kit) 19 which allows the user device 18 to send a request to the URL (Universal Resource Locator) of, in this example, Recommendation Server 12′. The SDK can, for example, be embedded in a player provided to the user device 18 by Publisher 16, A Request will include, as a minimum, the IP address of the user device 18 so that the Recommendation Server 12′ may send its Reply (e.g. the Priority List) back to the user device 18. However, the SDK may provide additional data concerning, by way of non-limiting example, the user, the user device, its environment and/or how it is being used to the Recommendation Server 12′.

When the user device 18 is a computer 18A, or another user device that can support a web browser, part of the Request can include what is known as a “cookie.” A cookie is a relatively small file of information about a user device which may include demographics, personal information, browser history, context and other information or Attributes that can help with the ad selection process. However, cookies are being increasingly disabled and/or blocked for privacy purposes and they are not generally used on user devices (such as many mobile devices) by application programs (“apps”) that don't implement a web browser.

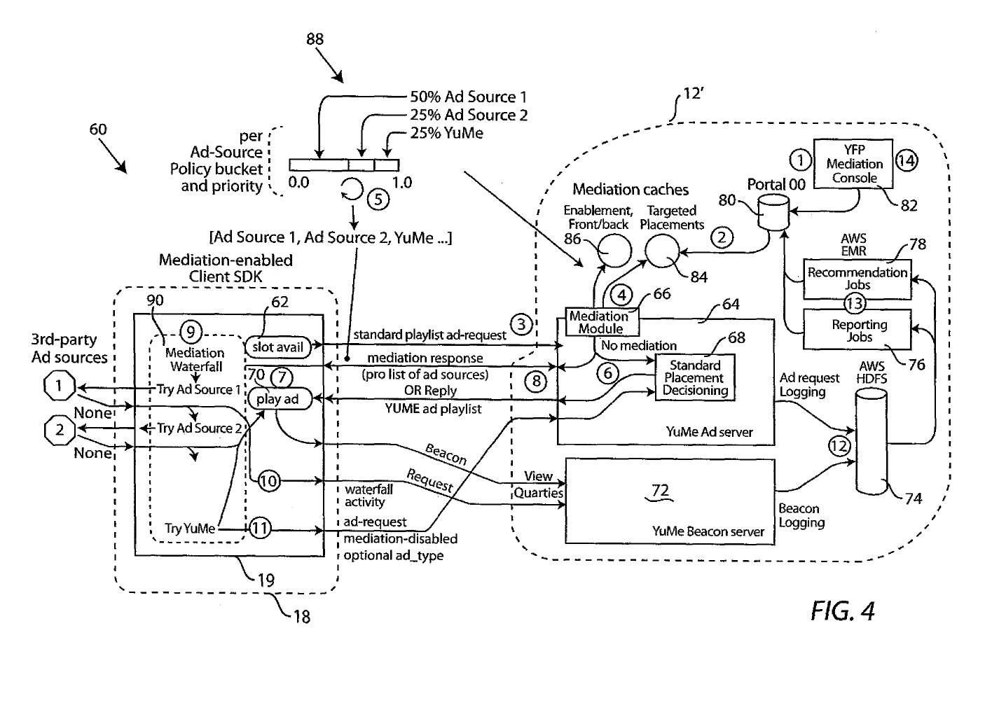

FIG. 4 is an illustration, set forth by way of example and not limitation, of a mediation recommendation system/method 60 for multiple demand sources. In the example system/method 60, a mediation enabled SDK 19 of a client device 18 indicates that a “slot” (e.g. a location for an ad) is available at 62 and sends a Request to an Ad server 64 of an Recommendation Server 12′ where it is received by a Mediation Module 66. If there is to be no mediation, a Standard Placement Decision 68 is made, and a Reply with an ad playlist is made to the SDK 19. A player 70 of the SDK 19 then plays the ad and information concerning its viewing is sent to a Beacon server 72.

As well known to those of skill in the art, a Web beacon is an object that is embedded in the advertisement that is usually invisible to a user but allows the detection of whether the user has viewed the advertisement. Typically, a Web beacon is small (e.g. 1×1 pixels) transparent gif image (or an image of the same color as the background) that is embedded into the HTML of the advertisement so that the viewing of the advertisement sends a Beacon Request to the Beacon server. The Ad Request data is stored by the Ad server 64 in a database 74 and the Beacon Request data is stored by the Beacon server 72 in the database 74.

The database 74 can be used by a Reporting module and a Recommendation module (“engine”) 78. A database 80 can be used to store the outputs of the Reporting model and the Recommendation module 78 for access by a Mediation Console 82. The database 80 is also used by a Mediated Target Placement cache 84 for targeted placements. The Mediation Module 66 is coupled to the Mediated Target Placement cache 84 and to a Mediation Enablement Front/back cache 86.

If a publisher provides an Ad Source Policy bucket 88 and priority to the Ad Server 64, then Mediation module 66 provides for the allocation of ads among the various demand sources. This will be referred to herein as a “Priority List.” In this example, a demand source Ad_Source_1 is allocated 50% of the ads, demand source Ad_Source_2 is allocated 25% of the ads, and demand source YuMe is allocated 25% of the ads as the Priority List. In this example, an Ad Request from SDK 19 at 62 will result in a Mediation Response Reply to the SDK 19 which can be handled, by way of non-limiting example, by a Mediation Waterfall process 90 which first tries Ad_Source_1, then Ad_Source_2, and then YuMe demand sources in order to fulfill the Ad Request. In an alternate example embodiment, a publisher can override the recommendation process and can manually set priorities with respect to demand sources.

The ordering of the Mediation Waterfall process 90 can be automatically changed by changing the Priority List, as will be appreciated by those of skill in the art, in response to the number of successful fulfillments from each of the demand sources. If the Mediation Waterfall process 90 is successful in fulfilling an Ad Request, the Ad is played at 70 and a Beacon Request is sent to the Beacon server 72 as described previously. Also, Waterfall activity data is sent to the Beacon server 72. This data at Beacon server 72 is processed as described above. If the Mediation Waterfall process is unsuccessful in fulfilling the Ad Request, an Ad Request Mediation Disabled is sent to the Standard Placement Decision 68 to be handled as described previously.

Recommendation systems have a number of properties including: \textcircled{1} user preference; \textcircled{2} prediction accuracy; \textcircled{3} coverage (e.g. publisher/demand source); \textcircled{4} confidence; \textcircled{5} trust (e.g. show recommendation for few demand sources that a publisher already knows and likes to build trust in the recommendation system); \textcircled{6} novelty; \textcircled{7} serendipity (e.g. a measure of how surprising the successful recommendation is); \textcircled{8} diversity; \textcircled{9} utility (e.g. many e-commerce sites employ in order to improve revenue, but also can be diversity or serendipity); \textcircled{10} risk (e.g. expected revenue but also minimize risk); \textcircled{11} robustness (e.g., can the system be gamed?); \textcircled{12} privacy (e,g. do the publisher's preferences remain private?); \textcircled{13} adaptability; and \textcircled{14} scalability (e.g. can it scale to thousands of publishers and tens of demand sources per publisher). Locations which address these properties in mediation recommendation system/method 60 are labeled accordingly.

It will therefore be appreciated that, in an embodiment set forth by way of example and not limitation, a mediation recommendation system/method 60 for multiple demand sources is provided by embedding a mediation-enabled SDK 19 into a client device 18. In this example, when the SDK 19 makes an Ad Request, a mediation process is initiated on an Ad Server 64 using an Ad Source Policy bucket and priority 88 that is provided by the publisher associated with that Ad Request. Throughout the process of providing and playing the ad on the client device, data concerning the selection, receipt and play of the ad is gathered by the Ad Server 64 and an associated Beacon server 72 and stored on a database 74 for analysis.

In an embodiment, set forth by way of example and not limitation, a Recommendation engine 78 can use the database 74, along with other information it may have at its disposal, to recommend a change in ad sources and/or allocation among ad sources using, for example, content based approaches, collaborative filtering approaches, or hybrids thereof. These recommendations can be of various types, including economic recommendations, recommendations to increase user interactivity and/or usability, etc.

Although various examples have been described using specific terms and devices, such description is for illustrative purposes only. The words used are words of description rather than of limitation. It is to be understood that changes and variations may be made by those of ordinary skill in the art without departing from the spirit or the scope of any examples described herein. In addition, it should be understood that aspects of various other examples may be interchanged either in whole or in part. It is therefore intended that the claims be interpreted in accordance with the true spirit and scope of the invention without limitation or estoppel.

What is claimed is:

1. A mediation recommendation system comprising:
a user device having a first digital processor, a first non-transient computer readable media, and a first network interface, where the first computer readable media includes mediation-enabled client Software Design Kit (SDK) program instructions executable on the first digital processor to provide a mediation waterfall and to communicate via the first network interface; and
a recommendation server including a second digital processor, a second non-transient computer readable media, and a second network interface, the second computer readable media including program instructions executable on the second digital processor to provide recommendations and to communicate via the second network interface.

2. A mediation recommendation system as recited in claim 1 wherein the mediation waterfall of the user device causes the user device to first try to obtain an advertisement (ad) from a first 3^{rd} party ad source.

3. A mediation recommendation system as recited in claim 2 wherein the mediation waterfall of the user device causes the user device to second try to obtain an ad from a second 3^{rd} party ad source if it was unable to obtain an ad from the first 3^{rd} party ad source.

4. A mediation recommendation system as recited in claim 1 wherein the user device makes a standard playlist ad request, whereby the recommendation server replies with an ad playlist.

5. A mediation recommendation system as recited in claim 1 wherein the recommendation server includes an advertisement (ad) server.

6. A mediation recommendation system as recited in claim 5 wherein the ad server includes a standard placement decision module and a mediation module.

7. A mediation recommendation system as recited in claim 6 wherein the recommendation server includes a beacon server.

8. A mediation recommendation system as recited in claim 7 further comprising a first database shared by the ad server and the beacon server.

9. A mediation recommendation system as recited in claim 8 further comprising a recommendation engine coupled to the first database.

10. A mediation recommendation system as recited in claim 9 further comprising a second database coupled to the recommendation engine.

11. A mediation recommendation system as recited in claim 10 further comprising a mediation console coupled to the second database.

12. A mediation recommendation system as recited in claim 11 wherein the mediation module is coupled to the second database.

13. A method for mediation and recommendation for multiple electronic demand sources comprising:
receiving at an advertisement (ad) server an ad request from a user device;
initiating a mediation process on the ad server using an ad source policy and a priority that is provided with a publisher associated with the ad request; and
providing 3^{rd} party ad source recommendations to the user device.

14. A method for mediation and recommendation for multiple electronic demand sources as recited in claim 13 further comprising running a mediation waterfall process on the user device with respect to the 3^{rd} party ad source recommendations.

15. A method for mediation and recommendation for multiple electronic demand sources as recited in claim 14 further comprising receiving information concerning the selection, receipt and play of an ad from the user device.

16. A method for mediation and recommendation for multiple electronic demand sources as recited in claim 15 further comprising receiving beacon information from the client device.

17. A method for mediation and recommendation for multiple electronic demand sources as recited in claim 16 further comprising storing selection, receipt, play and beacon information in a database for analysis.
